(19) United States
(12) Patent Application Publication
(10) Pub. No.: US 2008/0246955 A1
(43) Pub. Date: Oct. 9, 2008

(54) Method of detecting alcohol concentration and alcohol concentration detecting apparatus

(75) Inventors: Rie Osaki, Anjo-city (JP); Naoya Katoh, Ama-gun (JP); Noriyasu Amano, Gamagori-city (JP); Tetsuro Serai, Nukata-gun (JP); Akikazu Uchida, Kariya-city (JP); Yukihiro Tsukasaki, Susono-city (JP); Keiichiro Aoki, Numazu-city (JP)

Correspondence Address: NIXON & VANDERHYE, PC, 901 NORTH GLEBE ROAD, 11TH FLOOR, ARLINGTON, VA, 22203, US

(73) Assignees: NIPPON SOKEN, INC., Nishio-city (JP); DENSO CORPORATION, Kariya-city (JP); TOYOTA JIDOSHA KABUSHIKI KAISHA, Toyota-city (JP)

(21) Appl. No.: 12/078,389

(22) Filed: Mar. 31, 2008

(30) Foreign Application Priority Data
Apr. 9, 2007 (JP) 2007-102166
Dec. 21, 2007 (JP) 2007-330691

(51) Int. Cl. G01N 21/00

(52) U.S. Cl. 356/73

(57) ABSTRACT

In a detection of an alcohol concentration, a first light and a second light are irradiated to a mixed liquid including a fossil fuel, an alcohol, and water, and the alcohol concentration is calculated based on amounts of the first light and the second light permeated through the mixed liquid. In the detection, a difference of a transmittance of the fossil fuel with respect to the first light and each transmittance of the alcohol and water with respect to the first light is larger than a first value. In addition, a difference of a transmittance of water with respect to the second light and each transmittance of the fossil fuel and the alcohol with respect to the second light is larger than a second value.

### CROSS REFERENCE TO RELATED APPLICATION

This application is based on Japanese Patent Applications No. 2007-102166 filed on Apr. 9, 2007, and No. 2007-330691 filed on Dec. 21, 2007, the contents of which are incorporated herein by reference in their entirety.

### BACKGROUND OF THE INVENTION

1. Field of the Invention

The present invention relates to a method of detecting an alcohol concentration and/or relates to an alcohol concentration detecting apparatus.

2. Description of the Related Art

JP-2005-201670A discloses an alcohol concentration sensor for detecting an alcohol concentration in a mixed liquid including alcohol and gasoline. The mixed liquid is used as fuel for an engine, and the alcohol concentration sensor is attached to the engine. The alcohol concentration sensor includes an insulating substrate having a relative permittivity less than or equal to five, and a pair of thin-film electrodes disposed on a surface of the insulating substrate for providing an electric capacitance. The alcohol concentration sensor detects the electric capacitance corresponding to the alcohol concentration in accordance with a change in an output frequency of an oscillation circuit, and calculates the alcohol concentration based on the change in the output frequency.

Because alcohol easily contains moisture, the mixed liquid of alcohol and gasoline generally contains moisture. When moisture is attached to the thin-film electrode of the alcohol concentration sensor, an accuracy of detecting the alcohol concentration may be reduced. For example, the alcohol concentration sensor may detect a total concentration of alcohol and moisture as the alcohol concentration, and thereby the detected alcohol concentration may be higher than an actual alcohol concentration. Thus, when the engine is controlled based on the detected alcohol concentration, an engine performance, e.g., a generating torque and an amount of combustion products, may fluctuate.

Furthermore, when moisture is attached to the thin-film electrode, the thin-film electrode may be deteriorated or corroded, and thereby the alcohol concentration sensor may be difficult to detect the alcohol concentration accurately.

### SUMMARY OF THE INVENTION

It is therefore an object of the present invention to provide a method of detecting an alcohol concentration, and another object of the invention is to provide an alcohol-concentration detecting apparatus.

According to a first aspect of the invention, a method of detecting an alcohol concentration includes: irradiating a mixed liquid including a fossil fuel, an alcohol, and water with a first light, in which a difference of a transmittance of the fossil fuel with respect to the first light and each transmittance of the alcohol and water with respect to the first light is larger than a first value; detecting an amount of the first light permeated through the mixed liquid; irradiating the mixed liquid with a second light, in which a difference of a transmittance of water with respect to the second light and each transmittance of the fossil fuel and the alcohol with respect to the second light is larger than a second value; detecting an amount of the second light permeated through the mixed liquid; calculating a water concentration based on the amount of the permeated second light; and calculating the alcohol concentration based on the amount of the permeated first light and the calculated water concentration.

In this method, a concentration of the fossil fuel and a concentration of mixture of the alcohol and water can be calculated based on the amount of the permeated first light. Additionally, the water concentration and a concentration of a mixture of the fossil fuel and the alcohol can be calculated based on the amount of the permeated second light. Thus, the alcohol concentration can be calculated by subtracting the water concentration from the concentration of the mixture of the alcohol and water. Thereby, the alcohol concentration can be detected with high accuracy.

According to a second aspect of the invention, an alcohol-concentration detecting apparatus includes a body, a first light-emitting part, a first light-receiving part, a second light-emitting part, and a second light-receiving part. The body defines a passage in which a mixed liquid including a fossil fuel, an alcohol, and water flows. The first light-emitting part is disposed to emit a first light toward the mixed liquid in the passage, in which a difference of a transmittance of the fossil fuel with respect to the first light and each transmittance of the alcohol and water with respect to the first light is larger than a first value. The first light-receiving part is configured to selectively receive the first light permeated through the mixed liquid. The second light-emitting part is disposed to emit a second light toward the mixed liquid in the passage, in which a difference of a transmittance of water with respect to the second light and each transmittance of the fossil fuel and the alcohol with respect to the second light is larger than a second value. The second light-receiving part is configured to selectively receive the second light permeated through the mixed liquid.

According to a third aspect of the invention, an alcohol-concentration detecting apparatus includes a body, a first light-emitting part, a second light-emitting part, and a light-receiving part. The body defines a passage in which a mixed liquid including a fossil fuel, an alcohol, and water flows. The first light-emitting part is disposed to emit a first light toward the mixed liquid in the passage, in which a difference of a transmittance of the fossil fuel with respect to the first light and each transmittance of the alcohol and water with respect to the first light is larger than a first value. The second light-emitting part is disposed to emit a second light toward the mixed liquid in the passage, in which a difference of a transmittance of water with respect to the second light and each transmittance of the fossil fuel and the alcohol with respect to the second light is larger than a second value. The light-receiving part is configured to receive the first light and the second light permeated through the mixed liquid.

In the above-described alcohol-concentration detecting apparatuses, a concentration of a mixture of the alcohol and water can be calculated based on an amount of the permeated first light, and a water concentration can be calculated based on an amount of the permeated second light. Thus, the alcohol concentration can be calculated by subtracting the water concentration from the concentration of the mixture of the alcohol and water. Thereby, the above-described alcohol-concentration detecting apparatuses can detect the alcohol concentration with high accuracy.

### BRIEF DESCRIPTION OF THE DRAWINGS

Additional objects and advantages of the present invention will be more readily apparent from the following detailed description of preferred embodiment when taken together with the accompanying drawings. In the drawings:

FIG. 1 is a schematic diagram showing an engine control apparatus including an ethanol concentration sensor according to an embodiment of the invention;

FIG. 2 is a cross-sectional view showing the ethanol concentration sensor;

FIG. 3 is a flow diagram showing an ethanol-concentration detecting process performed using the ethanol concentration sensor;

FIG. 4 is a graph showing a relationship between each transmittance of gasoline, ethanol and water, and a wavelength of light;

FIG. 5 is a cross-sectional view showing an ethanol concentration sensor according to a first modification of the embodiment;

FIG. 6 is a schematic diagram showing a light-emitting diode according to the first modification;

FIG. 7 is a timing chart of a voltage to be applied to a first light-emitting diode part, a voltage to be applied to a second light-emitting diode part, and a voltage output from a phototransistor; and

FIG. 8 is a cross-sectional view showing an ethanol concentration sensor according to a second modification of the embodiment.

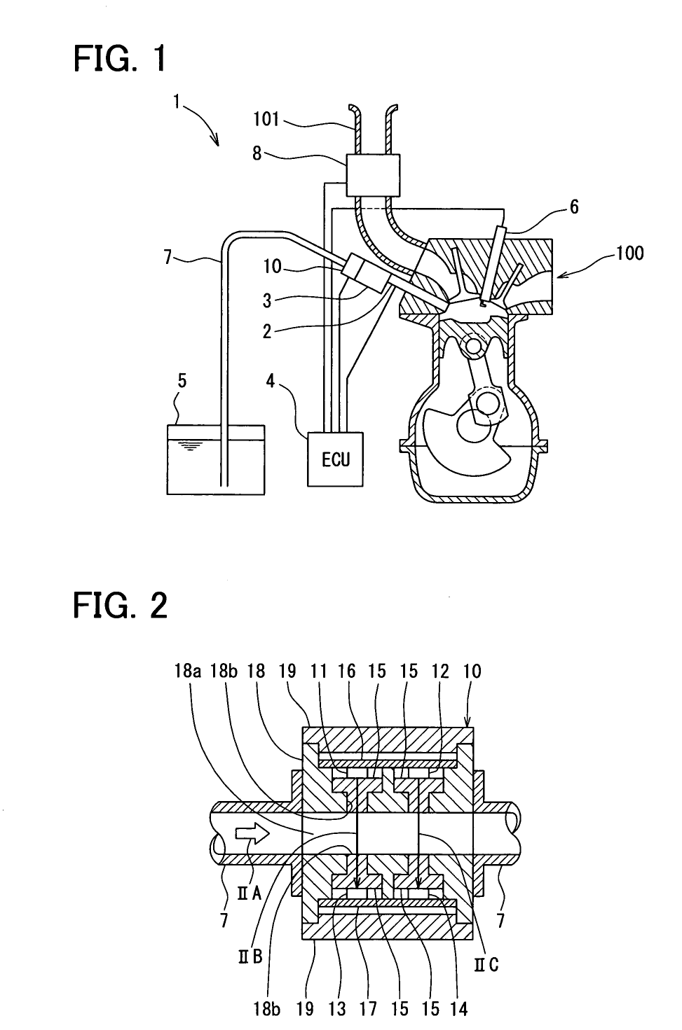

### DETAILED DESCRIPTION OF THE PREFERRED EMBODIMENT

An alcohol-concentration detecting apparatus according to an embodiment of the invention can be suitably used for an ethanol concentration sensor 10 for detecting an ethanol concentration in fuel that is supplied to a vehicular engine 100 by using an engine control apparatus 1.

The engine control apparatus 1 controls amounts of fuel and intake air to be supplied to the engine 100 in accordance with a running condition of a vehicle, so that a predetermined torque is generated, a fuel consumption is reduced, and an amount of toxic emission is reduced. The engine control apparatus 1 includes an injector 2, a delivery pipe 3, an electronic control unit (ECU) 4, an ignition plug 6, a fuel pipe 7, and a throttle valve 8. The injector 2 extends into a combustion chamber of the engine 100 to supply fuel into the combustion chamber. The delivery pipe 3 is coupled with the injector 2, and the fuel pipe 7 is coupled with the delivery pipe 3 and a fuel tank 5 so that fuel in the fuel tank 5 is supplied to the injector 2 through the fuel pipe 7 and the delivery pipe 3. The ignition plug 6 extends into the combustion chamber. The throttle value 8 is disposed at an intake pipe 101 of the engine 100. The ECU 4 includes a microcomputer, and controls an injection amount and an injection time of the injector 2, and an ignition time of the ignition plug 6. The ECU 4 further controls the amount of intake air by controlling an opening degree of the throttle valve 8.

For example, gasoline as fossil fuel, ethanol as alcohol, or a mixed liquid of gasoline and ethanol may be used as fuel for the engine 100. Thus, the engine 100 can be operated by using any one of gasoline, ethanol, and the mixed liquid. When fuel is supplied to the fuel tank 5, one of gasoline and ethanol can be selected freely. Thus, the mixed liquid of gasoline and ethanol is usually stored in the fuel tank 5, and an ethanol concentration in the mixed liquid changes between before and after fuel is supplied to the fuel tank 5. For example, when gasoline is supplied to the fuel tank 5, the ethanol concentration in the mixed liquid decreases. In contrast, when ethanol is supplied to the fuel tank 5, the ethanol concentration in the mixed liquid increases.

A volatility and a calorific value of gasoline are different from those of ethanol. Thus, a volatility and a calorific value of the mixed liquid change in accordance with the ethanol concentration. The ethanol concentration sensor 10 is disposed to detect the ethanol concentration in the mixed liquid. The ECU 4 controls the injection amount and the injection time of the injector 2, the ignition time of the ignition plug 6, and the amount of intake air, based on the detected ethanol concentration. Thereby, the engine 100 can be operated at an optimum condition for reducing the fuel consumption and emissions of exhaust gas regardless the ethanol concentration.

As described above, when fuel is supplied to the fuel tank 5, one of gasoline and ethanol is supplied to the fuel tank 5. Because ethanol easily contains moisture, ethanol stored in a tank at a filling station contains moisture. Thus, fuel in the fuel tank 5 also contains moisture. As a result, fuel is a mixed liquid of gasoline, ethanol, and water.

The ethanol concentration sensor 10 is disposed at a portion of the fuel pipe 7 adjacent to an inlet of the delivery pipe 3. When the engine 100 includes a plurality of injectors 2, all the injectors 2 are coupled with the single delivery pipe 3, respectively.

As shown in FIG. 2, the ethanol concentration sensor 10 includes a body 18 for defining a passage 18a in which fuel flows. In the body 18, a first light-emitting diode (first LED) 11 is disposed to emit a first light toward fuel in the passage 18a, and a first phototransistor 13 is disposed to receive the first light permeated through fuel. Additionally, a second light-emitting diode (second LED) 12 is disposed to emit a second light toward fuel in the passage 18a, and a second phototransistor 14 is disposed to receive the second light permeated through fuel.

The body 18 is made of a non-translucent material, for example, metal or resin. In a center portion of the body 18, a through hole is provided to define the passage 18a. Two end portions of the passage 18a are coupled with the fuel pipe 7. Fuel flows in the fuel pipe 7 and the passage 18a in a direction shown by the arrow IIA in FIG. 2. The end portion of the passage 18a on an upstream side of a fuel flow is coupled with the fuel tank 5, and the other end portion of the passage 18a on a downstream side of the fuel flow is coupled with the delivery pipe 3. The body 18 has four window holes 18b each extending to the passage 18a. Specifically, a first pair of window holes 18b is provided on the upstream side of the fuel flow, and is coaxially located opposite to each other at both sides of the passage 18a. A second pair of window holes 18b is provided on the downstream side of the fuel flow, and is coaxially located opposite to each other at both side of the passage 18a. That is, the passage 18a is positioned between the first pair of opposite window holes 18b, and between the second pair of opposite window holes 18b.

The ethanol concentration sensor 10 further includes four window members 15 respectively fitted into the window holes 18b. The window members 15 are made of a translucent material, for example, a transparent and colorless glass or a transparent and colorless resin. The window members 15 are attached to the body 18 so that a sufficient airtightness is provided to fuel in the passage 18a.

The first LED 11 has a light-emitting surface, and the light-emitting surface is attached to the window member 15 that is fitted into one of the first pair of window holes 18b on the upstream side of the fuel flow. Thus, the first light emitted by the first LED 11 permeates through the window member 15, and enters fuel. The first light has a center wavelength about in a range from 1600 nm to 1800 nm. For example, the first light is 1700-nm light. In this case, 1700-nm light has various light components each having a wavelength around 1700 nm, and a center wavelength having the highest brightness is about 1700 nm.

The first phototransistor 13 has a light-receiving surface, and the light-receiving surface is attached to the window member 15 that is fitted into the other one of the first pair of window holes 18b. Thus, the first light, which is emitted by the first LED 11 and permeated through fuel, travels in a direction shown by the arrow IIB in FIG. 2, permeates through the window member 15, and enters the first phototransistor 13. The first phototransistor 13 has an especially high sensitivity to a light having a wavelength about 1700 nm. Thus, the first phototransistor 13 selectively detects 1700-nm light emitted by the first LED 11, and outputs a detected signal in accordance with the amount of the detected light.

The second LED 12 has a light-emitting surface, and the light-emitting surface is attached to the window member 15 that is fitted into one of the second pair of window holes 18b on the downstream side of the fuel flow. Thus, the second light emitted by the second LED 12 permeates through the window member 15, and enters fuel. The second light has a center wavelength about in a range from 1400 nm to 1500 nm. For example, the second light is 1400-nm light. In this case, 1400-nm light has various light components each having a wavelength around 1400 nm, and the center wavelength having the highest brightness is about 1400 nm.

The second phototransistor 14 has a light-receiving surface, and the light-receiving surface is attached to the window member 15 that is fitted in the other one of the second pair of window holes 18b. Thus, the second light, which is emitted by the second LED 12 and permeated through fuel, travels in a direction shown by the arrow IIC in FIG. 2, permeates through the window member 15, and enters the second phototransistor 14. The second phototransistor 14 has an especially high sensitivity to a light having a wavelength about 1400 nm. Thus, the second phototransistor 14 selectively detects 1400-nm light emitted by the second LED 12, and outputs a detected signal in accordance with the amount of the detected light.

Each of the first LED 11, the second LED 12, the first phototransistor 13, and the second phototransistor 14 is a chip type. The first LED 11 and the second LED 12 are mounted on a first circuit board 16. The first phototransistor 13 and the second phototransistor 14 are mounted on a second circuit board 17. Each of the first circuit board 16 and the second circuit board 17 is coupled with an exterior electric wiring (not shown) through a connector (not shown). The exterior electric wiring is disposed on an outside of the ethanol concentration sensor 10, and is coupled with the ECU 4. Thus, each of the first LED 11 and the second LED 12 emits light controlled by the ECU 4, and detected signals from the first phototransistor 13 and the second phototransistor 14 are input to the ECU 4.

As shown in FIG. 2, covers 19 are attached to the body 18. The covers 19 are made of metal or resin, for example. The covers 19 are disposed to air-tightly protect the first LED 11, the second LED 12, the first phototransistor 13, and the second phototransistor 14 housed in the body 18.

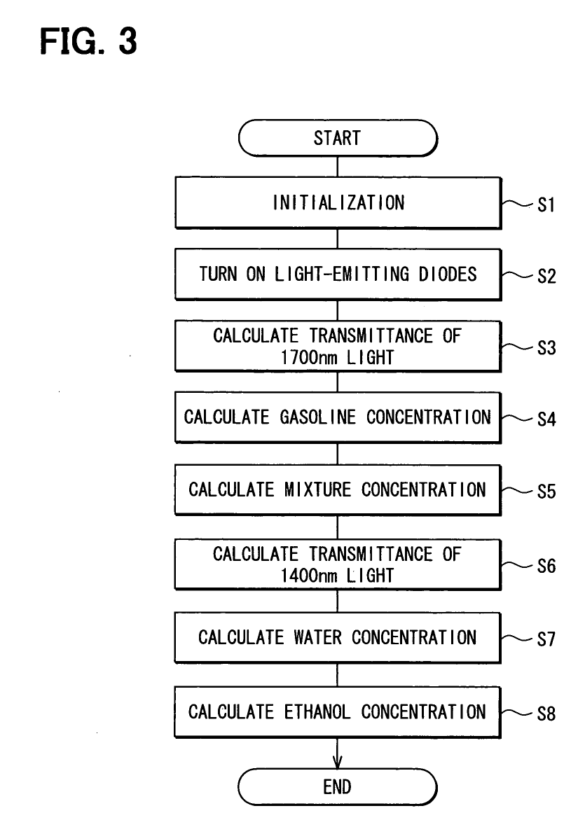

An ethanol-concentration detecting process using the ethanol concentration sensor 10 will now be described with reference to FIG. 3. The ethanol-concentration detecting process shown in FIG. 3 is performed by the ECU 4.

When an ignition switch of the engine 100 is turned on, the ECU 4 starts its operation, and the engine control apparatus 1 becomes in an operating state. The ECU 4 concurrently performs various processes related to the engine 100. However, only the ethanol-concentration detecting process will be described.

When the ECU 4 starts the ethanol-concentration detecting process, an initialization at S1 is performed. At S2, the ECU 4 turns on the first LED 11 and the second LED 12. The first phototransistor 13 detects 1700-nm light emitted by the first LED 11, and outputs the detected signal to the ECU 4 in accordance with the amount of the detected light. At S3, the ECU 4 calculates a transmittance of fuel with respect to 1700-nm light based on the detected signal from the first phototransistor 13. At S4, the ECU 4 calculates a gasoline concentration in fuel based on the transmittance of fuel with respect to 1700-nm light.

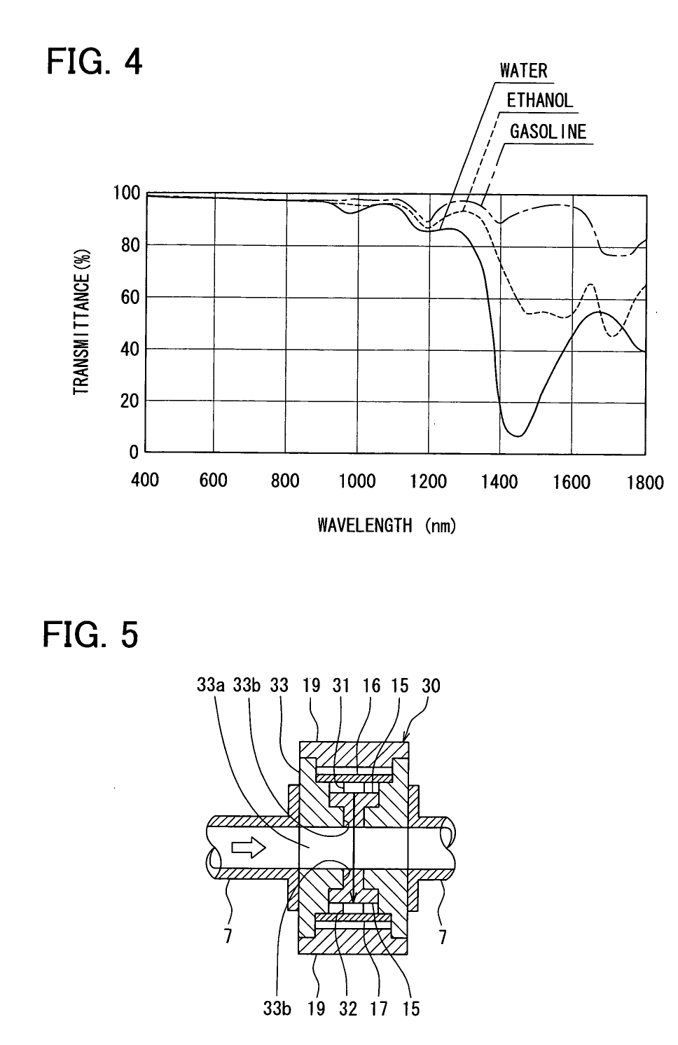

As shown in FIG. 4, transmittances of gasoline, ethanol, and water with respect to a light having a wavelength less than or equal to about 1200 nm are similar to each other. However, the transmittances of gasoline, ethanol, and water with respect to a light having a wavelength greater than about 1200 nm are different from each other. For example, the transmittances of ethanol and water with respect to 1700-nm light are similar to each other, but the transmittance of gasoline with respect to 1700-nm light is significantly higher than those of ethanol and water. Thus, in the mixed liquid of gasoline, ethanol, and water, gasoline can be discriminated from ethanol and water by using 1700-nm light. In this ethanol-concentration detecting process, a relationship between the gasoline concentration in the mixed liquid and the transmittance of the mixed liquid with respect to 1700-nm light is preliminary stored in a storing device in the ECU 4 as a map. Thus, the ECU 4 can calculate the gasoline concentration in fuel based on the map and the transmittance of fuel detected by the first phototransistor 13.

At S5, the ECU 4 calculates a concentration of a mixture of ethanol and water in fuel by subtracting the gasoline concentration from one. In this case, each of the concentrations of gasoline, ethanol, and water is between zero and one.

The second phototransistor 14 detects 1400-nm light emitted by the second LED 12, and outputs the detected signal to the ECU 4 in accordance with the amount of the detected light. At S6, the ECU 4 calculates a transmittance of fuel with respect to 1400-nm light based on the detected signal from the second phototransistor 14.

At S7, the ECU 4 calculates the water concentration in fuel based on the transmittance of fuel with respect to 1400-nm calculated at S6.

As shown in FIG. 4, the transmittances of gasoline and ethanol with respect to 1400-nm light are similar to each other, but the transmittance of water with respect to 1400-nm light is significantly lower than those of gasoline and ethanol. Thus, in the mixed liquid of gasoline, ethanol, and water, water can be discriminated from gasoline and ethanol by using 1400-nm light. In this ethanol-concentration detecting process, a relationship between the water concentration in the mixed liquid and the transmittance of the mixed liquid with respect to 1400-nm light is preliminary stored in the storing device in the ECU 4 as a map. Thus, the ECU 4 can calculate the water concentration in fuel based on the map and the transmittance of fuel detected by the second phototransistor 14.

At S8, the ECU 4 calculates the ethanol concentration in fuel by subtracting the water concentration calculated at S7 from the concentration of the mixture of ethanol and water calculated at S5.

In this ethanol-concentration detecting process, two lights having different wavelengths, i.e., 1700-nm light and 1400-nm light are emitted to fuel including gasoline, ethanol, and water, and 1700-nm light and 1400-nm light permeated through fuel are detected by the first phototransistor 13 and the second phototransistor 14, respectively. The transmittance of gasoline with respect to 1700-nm light is significantly higher than those of ethanol and water, and the transmittance of water with respect to 1400-nm light is significantly lower than those of gasoline and ethanol. That is, when a 1700-nm light is used, a difference between the light transmittance in gasoline and the light transmittance in ethanol or water is larger than a difference between the light transmittance in ethanol and the light transmittance in water. In contrast, when 1400-nm light is used, a difference between the light transmittance in water and the light transmittance in ethanol or gasoline is larger than a difference between the light transmittance in ethanol and the light transmittance in gasoline. Thus, the concentration of ethanol without moisture can be calculated based on the transmittances of fuel with respect to 1700-nm light and 1400-nm light.

An alcohol concentration detected by a conventional alcohol concentration sensor may be a concentration of a mixture of alcohol and water. In this case, when an engine is controlled based on the detected alcohol concentration, the engine may not be operated at the optimum condition for reducing a fuel consumption and emissions of exhaust gas.

However, in the ethanol-concentration detecting process using the ethanol concentration sensor 10 according to the embodiment of the present invention, the ethanol concentration in the mixed liquid of gasoline, ethanol, and water can be detected with high accuracy. That is, the concentration of ethanol without moisture can be detected. Thus, when the engine 100 is controlled based on the ethanol concentration detected by the ethanol concentration sensor 10, the engine 100 can be operated at the optimum condition for reducing the fuel consumption and the combustion emissions.

Additionally, the ethanol concentration sensor 10 emits the lights to fuel, and the transmittances of fuel with respect to the lights are calculated. In the ethanol concentration sensor 10, portions which directly contact with fuel are the window members 15. The window members 15 are made of the translucent material, for example, glass or resin. Because glass and resin are stable against fuel including gasoline, ethanol, and water, the window members 15 are difficult to be corroded by fuel. Thus, the ethanol concentration sensor 10 can permanently detected the ethanol concentration with high accuracy.

Next, some modifications of the embodiment will be described. An ethanol concentration sensor 30 according to a first modification of the embodiment includes a body 33 that has a passage 33a in which fuel flows, and two window holes 33b in which a pair of window members 15 is fitted, as shown in FIG. 5. The body 33 houses a light-emitting diode (LED) 31 and a phototransistor 32. The LED 31 and the phototransistor 32 are attached to the pair of window members 15 to be opposed to each other through the passage 33a, so that a light emitted by the LED 31 permeates through fuel and enters the phototransistor 32.

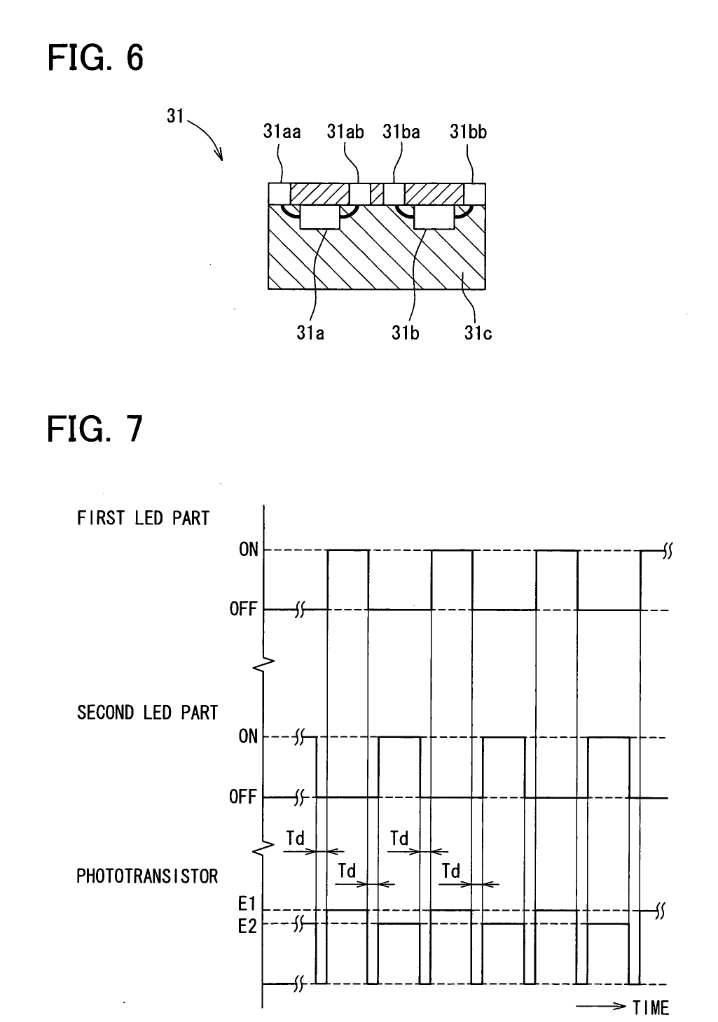

As shown in FIG. 6, the LED 31 includes a first LED part 31a and a second LED part 31b which are integrally formed. The first LED part 31a emits the first light having the center wavelength about in the range from 1600 nm to 1800 nm. For example, the first light is 1700-nm light having the center wavelength about 1700 nm. The second LED part 31b emits the second light having the center wavelength about in the range from 1400 nm to 1500 nm. For example, the second light is 1400-nm light having the center wavelength about 1400 nm. The LED 31 is formed as one element in which the first LED part 31a and the second LED part 31b are sealed by a molded translucent resin 31c. The first LED part 31a has two electrodes 31aa and 31ab, and the second LED part 31b has two electrodes 31ba and 31bb. When voltage is supplied to the electrodes 31aa and 31ab, the first LED part 31a emits 1700-nm light. When voltage is supplied to the electrodes 31ba and 31bb, the second LED part 31b emits 1400-nm light. Thus, the LED 31 functions as the first LED 11 in the ethanol concentration sensor 10 when voltage is supplied to the electrodes 31aa and 31ab, and functions as the second LED 12 in the ethanol concentration sensor 10 when voltage is supplied to the electrodes 31ba and 31bb.

The phototransistor 32 outputs an especially high level signal when the phototransistor 32 receives a light having a wavelength about in a range from 1400 nm to 1700 nm. Thus, the phototransistor 32 can output a detected signal in accordance with an amount of detected light in each case where the first LED part 31a emits 1700-nm light and where second LED part 31b emits 1400-nm light.

An ethanol-concentration detecting process using the ethanol concentration sensor 30 is basically similar with the ethanol-concentration detecting process using the ethanol concentration sensor 10 according to the embodiment, and is performed by the ECU 4. The transmittance of fuel with respect to 1700-nm light is calculated based on the amount of 1700-nm light detected by the phototransistor 32, and the transmittance of fuel with respect to 1400-nm light is calculated based on the amount of 1400-nm light detected by the phototransistor 32. Then, the ethanol concentration is calculated based on the detected transmittances.

An operating method of the LED 31 will now be described. As shown in FIG. 7, the first LED part 31a and the second LED part 31b are alternately emits light. Specifically, when the first LED part 31a is supplied with voltage and emits light (ON), the second LED part 31b is not supplied with voltage and does not emit light (OFF). In contrast, when the second LED part 31b is supplied with voltage and emits light (ON), the first LED part 31a is not supplied with voltage and does not emit light (OFF). The phototransistor 32 outputs a signal in accordance with the lights emitted by the first LED part 31a and the second LED part 31b. When the first LED part 31a emits light, an output voltage of the phototransistor 32 is voltage E1. When the second LED part 31b emits light, the output voltage of the phototransistor 32 is voltage E2. When the voltage supply to the first LED part 31a and the voltage supply to second LED part 31b are switched, a dead time Td, at which voltage is supplied neither to the first LED part 31a nor to the second LED part 31b, is provided. When the voltage is supplied to the first LED part 31a, the ECU 4 treats the output voltage of the phototransistor 32 as the amount of the permeated 1700-nm light. When the voltage is supplied to the second LED part 31b, the ECU 4 treats the output voltage of the phototransistor 32 as the amount of the permeated 1400-nm light.

In this way, the ethanol concentration sensor 30 can permanently detect the ethanol concentration with high accuracy similarly with the ethanol concentration sensor 10. Additionally, the ethanol concentration sensor 30 can detect the transmittances by using two electronic devices, i.e., the LED 31 and the phototransistor 32. Thus, the number of electronic devices used for detecting the transmittances can be reduced, and thereby a cost and a size of the ethanol concentration sensor 30 can be reduced.

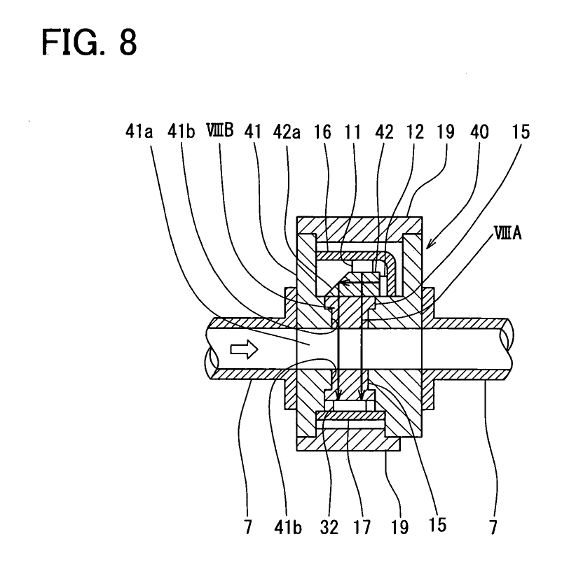

An ethanol concentration sensor 40 according to a second modification of the embodiment will be described with reference to FIG. 8. The ethanol concentration sensor 40 includes the first LED 11, the second LED 12, the phototransistor 32, and a body 41 that has a passage 41a in which fuel flows. The first LED 11 emits the first light having the center wavelength about in the range from 1600 nm to 1800 nm. For example, the first light is 1700-nm light having the center wavelength about 1700 nm. The second LED 12 emits the second light having the center wavelength about in the ranged from 1400 nm to 1500 nm. For example, the second light is 1400-nm light having the center wavelength about 1400 nm. The phototransistor 32 outputs an especially high level signal when the phototransistor 32 receives a light having a wavelength about in a range from 1400 nm to 1700 nm.

The body 41 has two window holes 41b, and a pair of window members 15 is fitted in the window holes 41b. The first LED 11 has the light-emitting surface, and the light-emitting surface is attached to a prism 42. The prism 42 is attached to one of the window members 15. The phototransistor 32 is attached to the other one of the window members 15. Thus, the first LED 11 and the phototransistor 32 are opposite to each other through the prism 42, the passage 41a, and the window members 15. The first light emitted by the first LED 11 travels straight through the prism 42, permeates through fuel flowing in the passage 41a, and enters the phototransistor 32, as shown by the arrow VIIIA in FIG. 8. The second LED 12 has the light-emitting surface, and the light-emitting surface is attached to the prism 42 in such a manner that an output direction of the second LED 12 is approximately perpendicular to that of the first LED 11. The prism 42 has a reflecting surface 42a. The second light emitted by the second LED 12 is reflected at the reflecting surface 42a of the prism 42, permeates through fuel flowing in the passage 41a, and enters the phototransistor 32, as shown by the arrow VIIIB in FIG. 8.

The ethanol concentration sensor 40 includes two light-emitting parts (i.e., the first LED 11 and the second LED 12) and one common light-receiving part (i.e., 16: the phototransistor 32). Thus, an ethanol-concentration detecting process using the ethanol concentration sensor 40 is similar with the ethanol-concentration detecting process using the ethanol concentration sensor 30. The first LED 11 and the second LED 12 alternately emits light, and the phototransistor 32 alternately outputs a signal corresponding to the amount of the permeated first light, and a signal corresponding to the amount of the permeated second light.

Also in the ethanol concentration sensor 40, the number of electronic devices used for detecting the transmittances can be reduced, and thereby a cost and a size of the ethanol concentration sensor 40 can be reduced.

In the ethanol concentration sensor 30 according to the first modification of the embodiment, and in the ethanol concentration sensor 40 according to the second modification of the embodiment, the phototransistor 32 outputs an especially high level signal when the phototransistor 32 receives the light having the wavelength about in the range from 1400 nm to 1700 nm. Alternatively, the phototransistor 32 may be formed as one element having a first phototransistor part and a second phototransistor part that are integrally sealed by a molded translucent resin. In this case, the first phototransistor part outputs an especially high level signal by receiving the first light having the center wavelength about in the range from 1600 nm to 1800 nm, and the second phototransistor part outputs an especially high level signal by receiving the second light having the center wavelength about in the range from 1400 nm to 1500 nm.

In the ethanol concentration sensors 10, 30, and 40, the phototransistors 13, 14, and 32 are used respectively as the light-receiving part. Alternatively, a photodiode may be used as the light-receiving part.

In the ethanol concentration sensors 10, 30, and 40, the first light and the second light can be selected such that a difference of a transmittance of the fossil fuel with respect to the first light and each transmittance of the alcohol and water with respect to the first light is larger than a first value, and a difference of a transmittance of water with respect to the second light and each transmittance of the fossil fuel and the alcohol with respect to the second light is larger than a second value. Furthermore, a difference of the transmittances of the alcohol and water with respective to the first light is smaller than the first value, and a difference of the transmittances of the fossil fuel and the alcohol with respect to the second light is smaller than the second value.

In the above-described embodiment and modifications, gasoline is used as fossil fuel, and ethanol is used as alcohol, as examples. However, fossil fuel and alcohol may be other materials. For example, diesel oil (light oil) may be used as fossil fuel and methanol may be used as alcohol. Also in this case, the wavelengths of the first light and the second light are selected in such a manner that a transmittance of the fossil fuel with respect to the first light is different from each transmittance of the alcohol and water with respect to the first light, and that a transmittance of water with respect to the second light is different from each transmittance of the fossil fuel and the alcohol with respect to the second light. Thereby, the alcohol concentration can be detected with high accuracy similarly with the above-described embodiment and modifications.

Such changes and modifications are to be understood as being within the scope of the present invention as defined by the appended claims.

What is claimed is:

1. A method of detecting an alcohol concentration in a mixed liquid including a fossil fuel, an alcohol, and water, the method comprising:
irradiating the mixed liquid with a first light, wherein a difference of a transmittance of the fossil fuel with respect to the first light and each transmittance of the alcohol and water with respect to the first light is larger than a first value;
detecting an amount of the first light permeated through the mixed liquid;
irradiating the mixed liquid with a second light, wherein a difference of a transmittance of water with respect to the second light and each transmittance of the fossil fuel and the alcohol with respect to the second light is larger than a second value;
detecting an amount of the second light permeated through the mixed liquid;
calculating a water concentration based on the amount of the permeated second light; and
calculating the alcohol concentration based on the amount of the permeated first light and the calculated water concentration.

2. The method according to claim 1, wherein:
a difference of the transmittances of the alcohol and water with respective to the first light is smaller than the first value; and
a difference of the transmittances of the fossil fuel and the alcohol with respect to the second light is smaller than the second value.

3. The method according to claim 1, wherein:
the fossil fuel is one of gasoline and diesel oil; and
the alcohol is one of ethanol and methanol.

4. The method according to claim 1, wherein:
the first light has a center wavelength about in a range from 1600 nm to 1800 nm; and
the second light has a center wavelength about in a range from 1400 nm to 1500 nm.

5. An alcohol-concentration detecting apparatus comprising:
a body for defining a passage in which a mixed liquid including a fossil fuel, an alcohol, and water flows;
a first light-emitting part disposed to emit a first light toward the mixed liquid in the passage, wherein a difference of a transmittance of the fossil fuel with respect to the first light and each transmittance of the alcohol and water with respect to the first light is larger than a first value;
a first light-receiving part configured to selectively receive the first light permeated through the mixed liquid;
a second light-emitting part disposed to emit a second light toward the mixed liquid in the passage, wherein a difference of a transmittance of water with respect to the second light and each transmittance of the fossil fuel and the alcohol with respect to the second light is larger than a second value; and
a second light-receiving part configured to selectively receive the second light permeated through the mixed liquid.

6. The alcohol-concentration detecting apparatus according to claim 5, wherein:
a difference of the transmittances of the alcohol and water with respective to the first light is smaller than the first value; and
a difference of the transmittances of the fossil fuel and the alcohol with respect to the second light is smaller than the second value.

7. The alcohol-concentration detecting apparatus according to claim 5, further comprising:
a first calculating means for calculating a water concentration based on an amount of the permeated second light received by the second light-receiving part; and
a second calculating means for calculating the alcohol concentration based on an amount of the permeated first light received by the first light-receiving part and the calculated water concentration.

8. The alcohol-concentration detecting apparatus according to claim 5, wherein:
the fossil fuel is one of gasoline and diesel oil; and
the alcohol is one of ethanol and methanol.

9. The alcohol-concentration detecting apparatus according to claim 5, wherein:
the first light has a center wavelength about in a range from 1600 nm to 1800 nm; and
the second light has a center wavelength about in a range from 1400 nm to 1500 nm.

10. The alcohol-concentration detecting apparatus according to claim 5, wherein:
the first light-emitting part and the second light-emitting part are integrally sealed with a molded resin to configurate a light-emitting element; and
the first light-receiving part and the second light-receiving part are integrally sealed with a molded resin to configurate a light-receiving element.

11. The alcohol-concentration detecting apparatus according to claim 10, wherein the light-emitting element is configured to emit the first light and the second light alternately.

12. The alcohol-concentration detecting apparatus according to claim 11, wherein the light-receiving element is configured to alternately output a first signal corresponding to an amount of the first light received by the first light-emitting part and a second signal corresponding to an amount of the second light received by the second light-emitting part.

13. An alcohol-concentration detecting apparatus comprising:
a body for defining a passage in which a mixed liquid including a fossil fuel, an alcohol, and water flows;
a first light-emitting part disposed to emit a first light toward the mixed liquid in the passage, wherein a difference of a transmittance of the fossil fuel with respect to the first light and each transmittance of the alcohol and water with respect to the first light is larger than a first value;
a second light-emitting part disposed to emit a second light toward the mixed liquid in the passage, wherein a difference of a transmittance of water with respect to the second light and each transmittance of the fossil fuel and the alcohol with respect to the second light is larger than a second value; and
a light-receiving part configured to receive the first light and the second light permeated through the mixed liquid.

14. The alcohol-concentration detecting apparatus according to claim 13, wherein:
a difference of the transmittances of the alcohol and water with respective to the first light is smaller than the first value; and
a difference of the transmittances of the fossil fuel and the alcohol with respect to the second light is smaller than the second value.

15. The alcohol-concentration detecting apparatus according to claim 13, further comprising:
a first calculating means for calculating a water concentration based on an amount of the permeated second light received by the light-receiving part; and
a second calculating means for calculating the alcohol concentration based on an amount of the permeated first light received by the light-receiving part and the calculated water concentration.

16. The alcohol-concentration detecting apparatus according to claim 13, wherein:
the fossil fuel is one of gasoline and diesel oil; and
the alcohol is one of ethanol and methanol.

17. The alcohol-concentration detecting apparatus according to claim 13, wherein:
the first light has a center wavelength about in a range from 1600 nm to 1800 nm; and
the second light has a center wavelength about in a range from 1400 nm to 1500 nm.

18. The alcohol concentration detecting apparatus according to claim 13, wherein the first light-emitting part and the second light-emitting part are integrally sealed with a molded resin.

19. The alcohol concentration detecting apparatus according to claim 13, wherein the first light-emitting part and the second light-emitting part are configured to emit the first light and the second light alternately.

20. The alcohol concentration detecting apparatus according to claim 19, wherein the light-receiving part is configured to alternately output a first signal corresponding to an amount of the first light received by the light-receiving part and a second signal corresponding to an amount of the second light received by the light-receiving part.
